(19) United States
(12) Patent Application Publication
(10) Pub. No.: US 2016/0339564 A1
(43) Pub. Date: Nov. 24, 2016

(54) SCREWDRIVER BIT STRUCTURE

(71) Applicant: Tuo-Jen Chen, Taichung (TW)

(72) Inventor: Tuo-Jen Chen, Taichung (TW)

(21) Appl. No.: 14/715,584

(22) Filed: May 18, 2015

(51) Int. Cl. B25B 15/00

(52) U.S. Cl. CPC B25B 15/001

(57) ABSTRACT

A screwdriver bit structure is disclosed and comprises a driving end, a connection end, and a neck portion. The driving end and the connection end are respectively extended from two ends of the neck portion outwardly. Two side portions are respectively formed at two sides of the connection end and two first abutting portions are respectively formed between the two side portions so that the two first abutting portions are respectively totally engaged at two opposite surfaces of a hexagonal hole of a tool waited for connection.

### BACKGROUND OF THE INVENTION

1. Field of the Invention

The present invention relates to a screwdriver bit structure, and especially relates to a screwdriver bit structure capable for reducing weight and volume, saving space, and carry easily.

2. Description of Related Art

Please refer to FIGS. 1 and 2, the screwdriver bit 10 has a driving end 11 and a connection end 12. And the driving end 11 and the connection end 12 are respectively extended from two ends of a neck portion 13. The driving end 11 is provided for a screwing tool 14 to use. The size of the screwing tool 14 to match the driving end 11 may be various. The shape of hole 142 of the head 141 of the screwing tool 14 may be linear, cross, star, quincunx, hexagonal, and etc. The connection end 12 may be provided for assembling into a sleeve 151 of a tool handle 15 to drive the driving end 11 of the screwdriver bit 10 and further lock together (it may also inserted into a slot of an electric tool handle, which the descriptions are omitted because it is prior art).

Please refer to FIG. 2, the connection end 12 is assembled and inserted into the hexagonal hole with equal side lengths (such as 6.35 mm) of the sleeve 151 of the tool handle 15. No matter what the sizes or types of the driving end 11 are, the connection end 12 of the screwdriver bit 10 must cooperate with the determined shape and size of the hexagonal hole of the sleeve 151. Some drawbacks are derived as below.

Firstly, the connection end 12 of the screwdriver bit 10 is only passively and totally cooperated with the shape and size of the sleeve. Therefore, the connection end 12 is still a hexagonal prism structure no matter what the size or type of the driving end 11 is or the size of the neck portion 13 is reduced. The designed size of the connection end 12 of the screwdriver bit 10 may increase the weight thereof while packaging for selling and the materials and cost may be wasted, especially for various types of tools. The space and weight of the tools are not easy and convenient to carry personally.

Secondly, the connection end 12 of the screwdriver bit 10 must cooperate with the size of the present sleeve 151 finally.

Thirdly, please refer to FIGS. 3 and 4, a dug space 101 is formed at the axis of the screwdriver bit 10 to reduce the weight of the screwdriver bit 10. This structure may sustain the additional torque force after experiment. The weight of the screwdriver bit 10 is reduced, but the volume thereof is still unchanged. And the dug space 101 is hard to manufacture and the cost is high.

In order to use the screwdriver bit 10 variously, conveniently, and more practically, the relative tool box 161 and 162 are disclosed, shown as FIGS. 5 and 6. The additional accommodation spaces 163 and 164 are provided for receiving more screwdriver bits 10. Although it becomes various and convenient, there are many drawbacks existed and described as below.

Firstly, no matter what the single space 163 of FIG. 5 is or the accommodation space 164 for a plurality of screwdriver bits 10 of FIGS. 6 and 7 is, the amount for receiving is larger and the accumulated weights are much heavier so that users must carry larger tool box with more screwdriver bits 10, especially carrying out or moving among different working places.

Secondly, the hand tool 17 for receiving screwdriver bit is that a accommodation portion 172 is formed at an inner space 171 of the hand tool 17 for receiving the screwdriver bit 10 so as to be easily carried and taken. The problem of larger volume and weight of the screwdriver bits is still not improved so that the weight and volume of the hand tool 17 carried by users may still not be reduced.

Therefore, the screwdriver bits 18 and 19 respectively shown as FIGS. 9 and 10 are developed and disclosed. That is, the recognition portions 181 and 191 are formed thereon respectively. The desire to buy may be excited and the products with the mentioned structures may be differentiated. But there are some problems needed to solved.

Firstly, the problems of larger volume and heavier weight of the screwdriver bit are still existed.

Secondly, although the recognition portions 181 and 191 are added, the cost is increased no matter how to form and manufacture. The selling markets are still restricted.

Thirdly, a ring concave portion (not shown) may be preserved to form the recognition portion 181 at the screwdriver bit 18 of FIG. 9. The difficulty of manufacturing is increased.

Fourthly, no matter what the screwdriver bit 18 of FIG. 9 or the screwdriver bit 19 of FIG. 10 is, the recognition portions 181 and 191 must be formed at the small surface (one surface of the hexagonal hole) so that the difficulty of manufacturing is increased. The problems of larger volume and heavier weight of the screwdriver bit are still not improved.

In view of the foregoing circumstances, the inventor has invested a lot of time to study the relevant knowledge, compare the pros and cons, research and develop related products. After quite many experiments and tests, the “screwdriver bit structure” of this invention is eventually launched to improve the foregoing shortcomings, to meet the public use.

### SUMMARY OF THE INVENTION

An object of this invention is providing a screwdriver bit structure to improve the drawbacks of the prior art. Compared to the conventional screwdriver bit, it may achieve the effects of volume and weight reduction, space saving, and carrying easily.

In order to achieve above mentioned effects, a screwdriver bit structure is provided. The screwdriver bit structure may comprise a driving end, a connection end, and a neck portion, wherein: the driving end and the connection end are respectively extended from two ends of the neck portion outwardly; and two side portions are respectively formed at two sides of the connection end and two first abutting portions are respectively formed between the two side portions so that the two first abutting portions are respectively totally engaged at two opposite surfaces of a hexagonal hole of a tool waited for connection.

In some embodiments, two second abutting portions are formed from each first abutting portion toward the side portion so that the two second abutting portion are partially engaged at another two opposite surfaces of the hexagonal hole of the tool waited for connection.

In order to achieve above mentioned effects, another screwdriver bit structure is further provided. The screwdriver bit structure may comprise a driving end, a connection end, and a neck portion, wherein: the driving end and the connection end are respectively extended from two ends of the neck portion outwardly; and two side portions are respectively formed at two sides of the connection end and two third abutting portions are respectively formed between the two side portions so that the two third abutting portions are respectively partially engaged at two opposite locations of two adjacent surfaces of a hexagonal hole of a tool waited for connection.

The various objectives and advantages of the present invention will be more readily understood from the following detailed description when read in conjunction with the appended drawing.

### BRIEF DESCRIPTION OF THE DRAWINGS

FIG. 1 is a perspective view of a first embodiment of a conventional screwdriver bit;

FIG. 2 is an assembled view of the conventional screwdriver bit and a sleeve;

FIG. 3 is a perspective view of a second embodiment of a conventional screwdriver bit;

FIG. 4 is a cross-sectional view of the second embodiment of the conventional screwdriver bit;

FIG. 5 is a perspective view of the conventional screwdriver bit inserted into a first embodiment of an accommodation portion of a tool box;

FIG. 6 is a perspective view of the conventional screwdriver bit inserted into a second embodiment of an accommodation portion of a tool box;

FIG. 7 is a cross-sectional view of the accommodation portion of the tool box of FIG. 6;

FIG. 8 is a perspective view of the conventional screwdriver bit inserted into a third embodiment of an accommodation portion of a tool box;

FIG. 9 is a perspective view of a first embodiment of a screwdriver bit with recognition function;

FIG. 10 is a perspective view of a second embodiment of a screwdriver bit with recognition function;

FIG. 11 is a perspective view of a first embodiment of a screwdriver bit structure of the present invention;

FIG. 12 is an assembled view of the first embodiment of the screwdriver bit structure of the present invention inserted into a sleeve.

FIG. 13 is another cross-sectional view of FIG. 12;

FIG. 14 is a view compared the screwdriver bit structure of present invention arranged in the tool box with the conventional screwdriver bit arranged in the tool box;

FIG. 15 is another view compared the screwdriver bit structure of present invention arranged in the tool box with the conventional screwdriver bit arranged in the tool box;

FIG. 16 is a perspective view of the second abutting portions of the first embodiment of the screwdriver bit structure of present invention;

FIG. 17 is an assembled view of the screwdriver bit structure of FIG. 16 and a sleeve; and

FIG. 18 is a perspective view of a second embodiment of a screwdriver bit structure of the present invention.

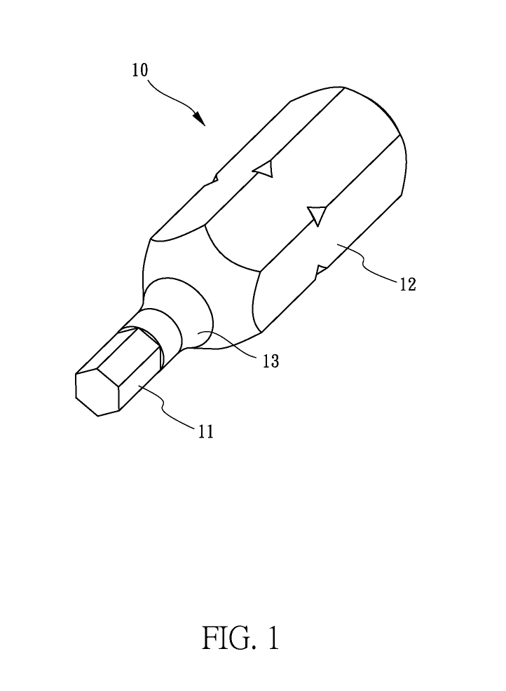

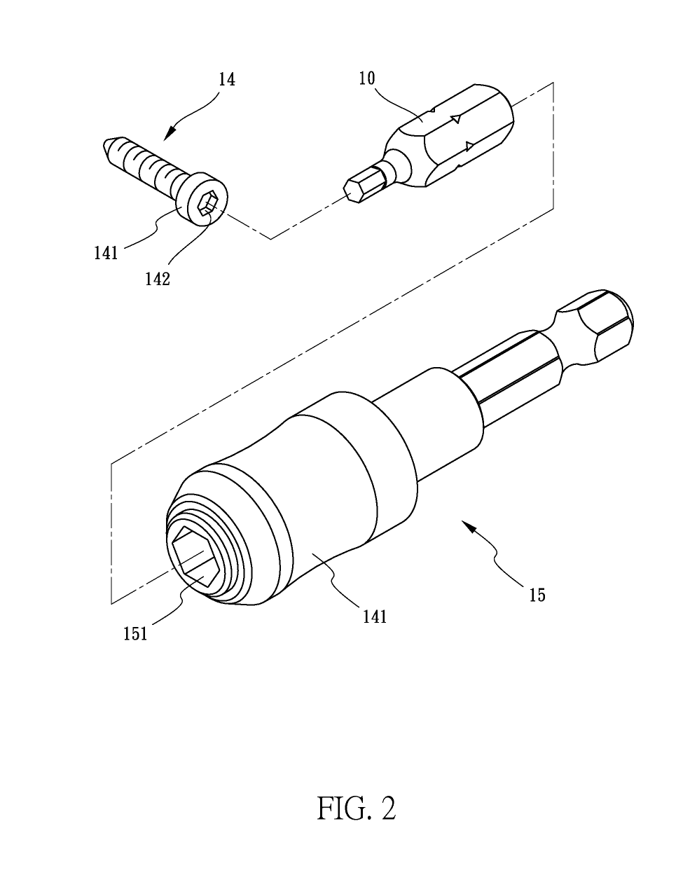

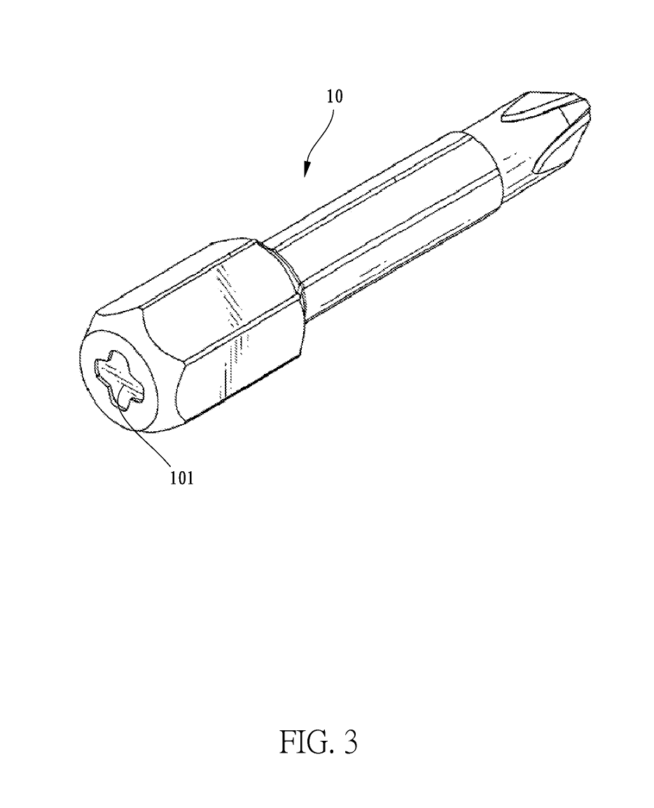

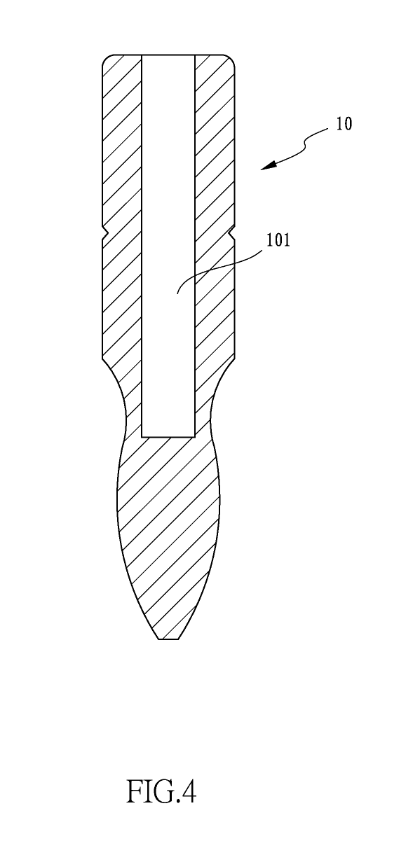

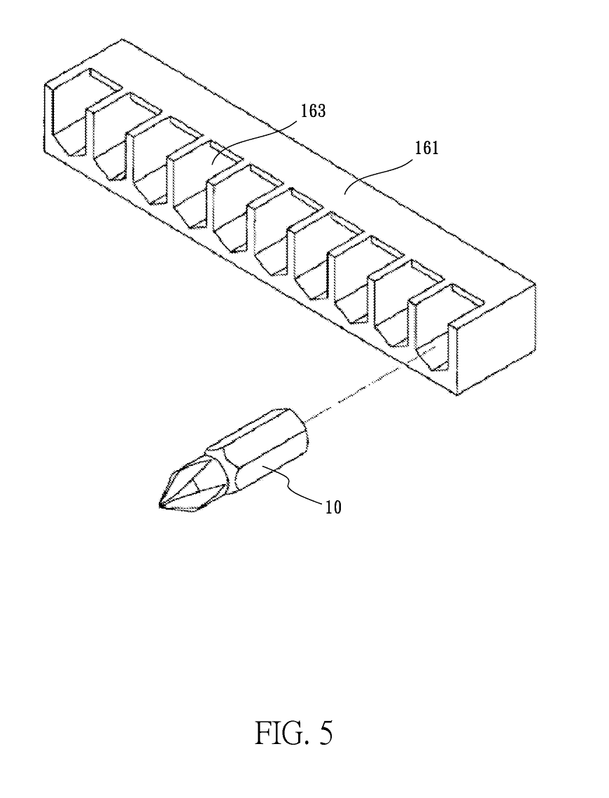

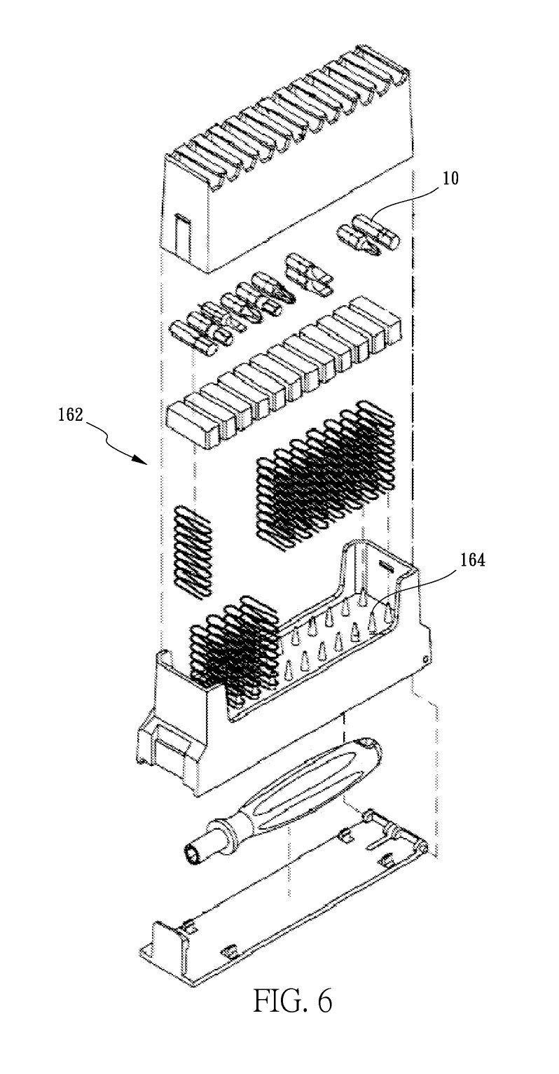

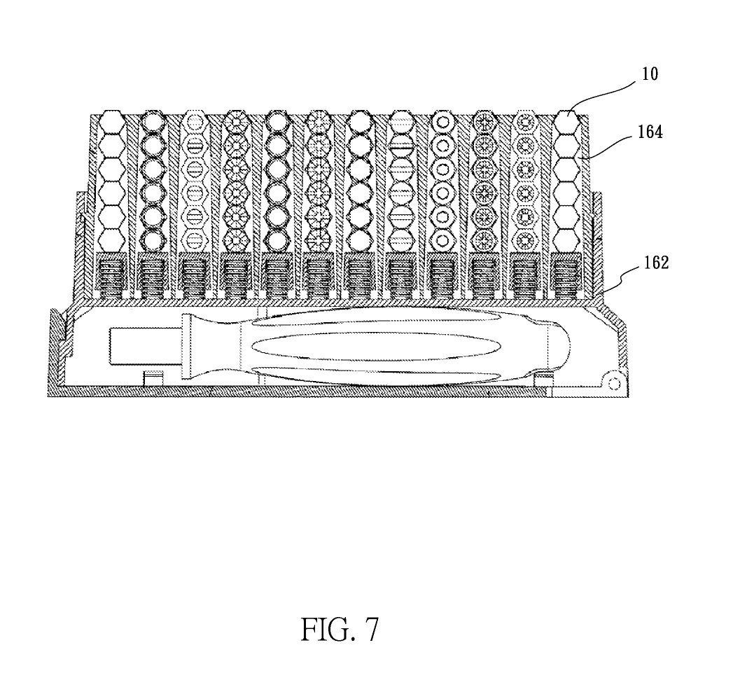

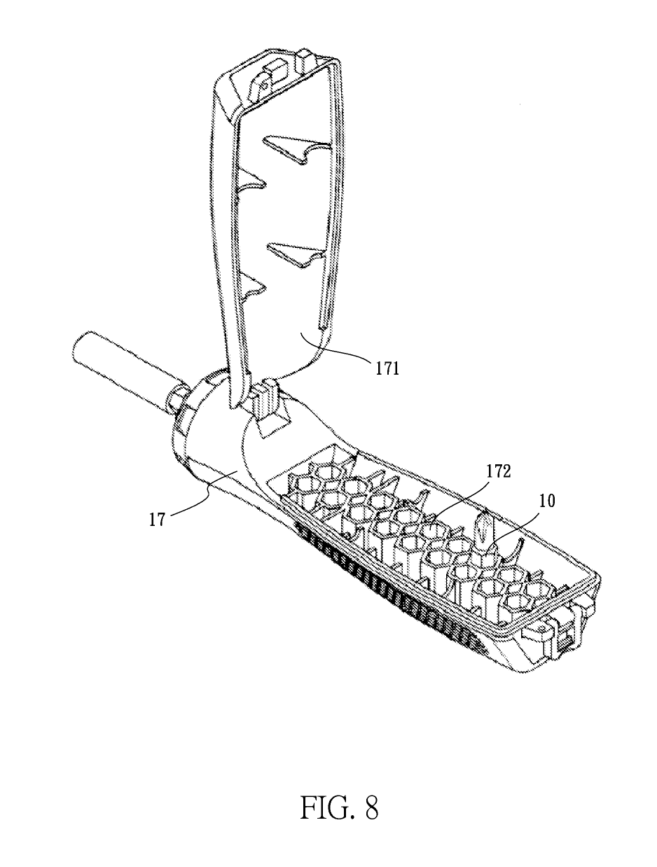

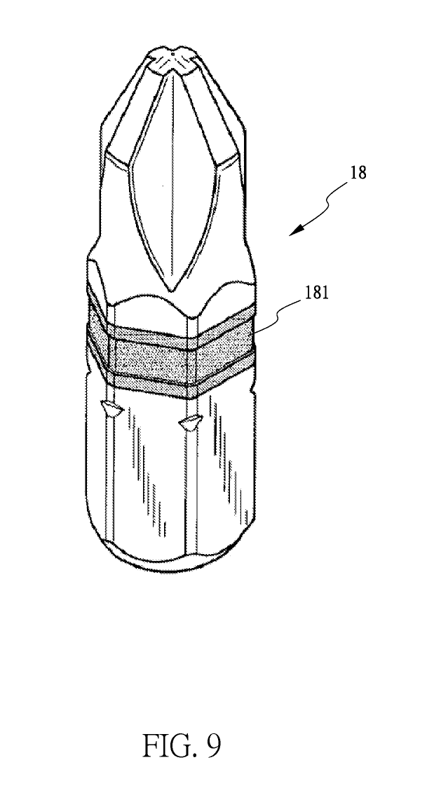

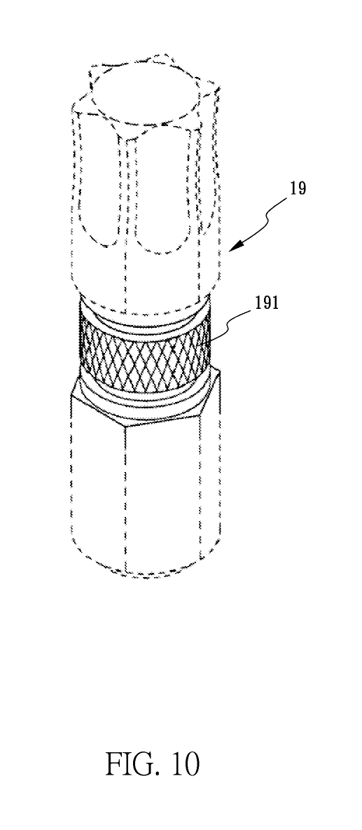

### DETAILED DESCRIPTION OF THE INVENTION

To describe clearly that the present invention achieves the foregoing objective and function, the technical features and desired function are described with reference to a preferred embodiment and accompanying drawings.

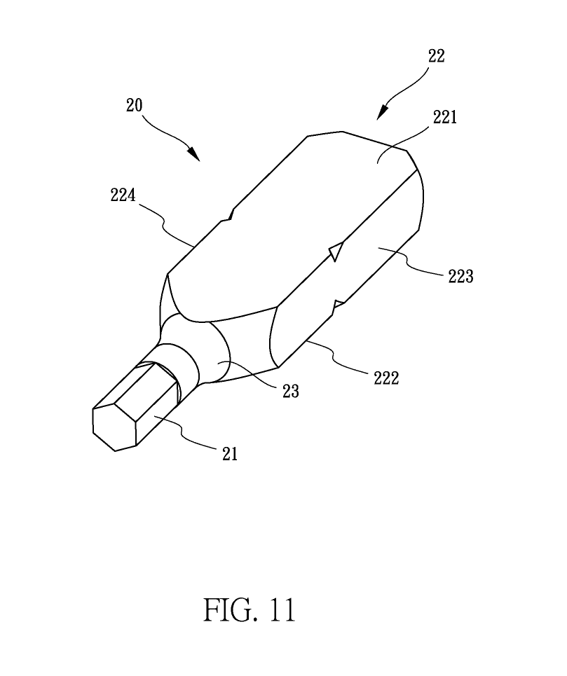

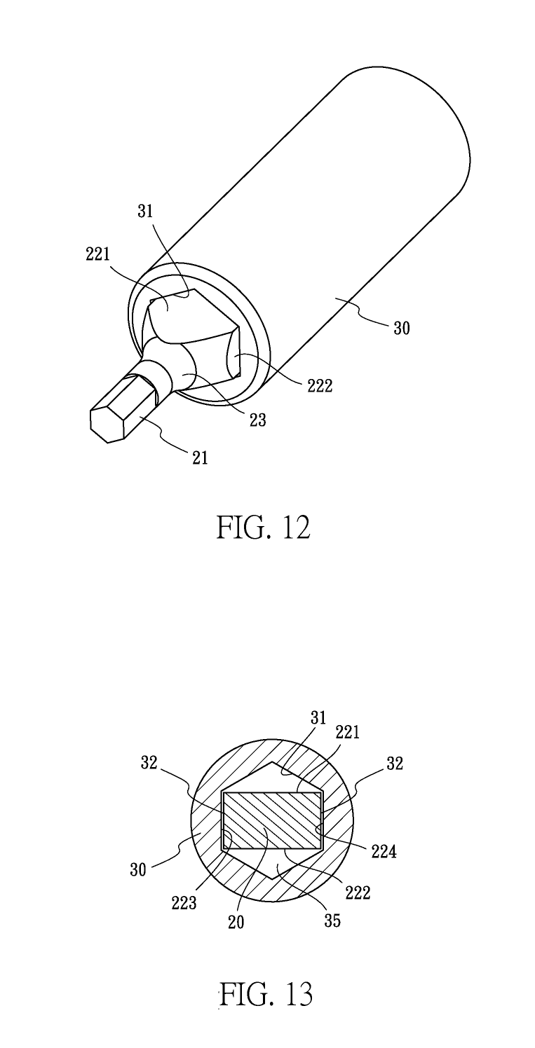

Please reference to FIGS. 11 to 13, a screwdriver bit structure 20 of present invention comprises a driving end 21, a connection end 22, and a neck portion 23. The driving end 21 and the connection end 22 are respectively extended from two ends of the neck portion 23 outwardly. Two side portions 221 and 222 are respectively formed at two sides of the connection end 22 and two first abutting portions 223 and 224 are respectively formed between the two side portions 221 and 222 so that the two first abutting portions 223 and 224 are respectively totally engaged at two opposite surfaces 32 of a hexagonal hole 31 of a tool 30 which is waited for connection.

Since the two first abutting portions 223 and 224 are respectively totally engaged at two opposite surfaces 32 of a hexagonal hole 31 of a tool 30 which is waited for connection, the two first abutting portions may be respectively against the opposite surfaces 32 of the hexagonal hole 31 of the tool 30. Besides the connection end 22 may sustain the full force of the total screwdriver bit structure 20, the total volume of a plurality of the screwdriver bit structures may be reduced (that is, the space between the connection end and the hexagonal hole 31 of the tool 30, such as the reduced space 35 of FIG. 13). There are some effects described as below.

Firstly, since the two first abutting portions 223 and 224 are respectively totally engaged at two opposite surfaces 32 of a hexagonal hole 31 of a tool 30 which is waited for connection, it may cooperate with the conventional hexagonal hole 31 and the conventional tool 30 is not necessary to be modified.

Secondly, the volume 33 of the screwdriver bit structure 20 of present invention is effectively reduced, and so does the weight thereof.

Thirdly, the screwdriver bit structure 20 of present invention is firmly because the hollow structure formed at the axis thereof is not necessary.

Fourthly, the weight of the screwdriver bit structure 20 of present invention may be reduced, even the volume thereof may not be reduced.

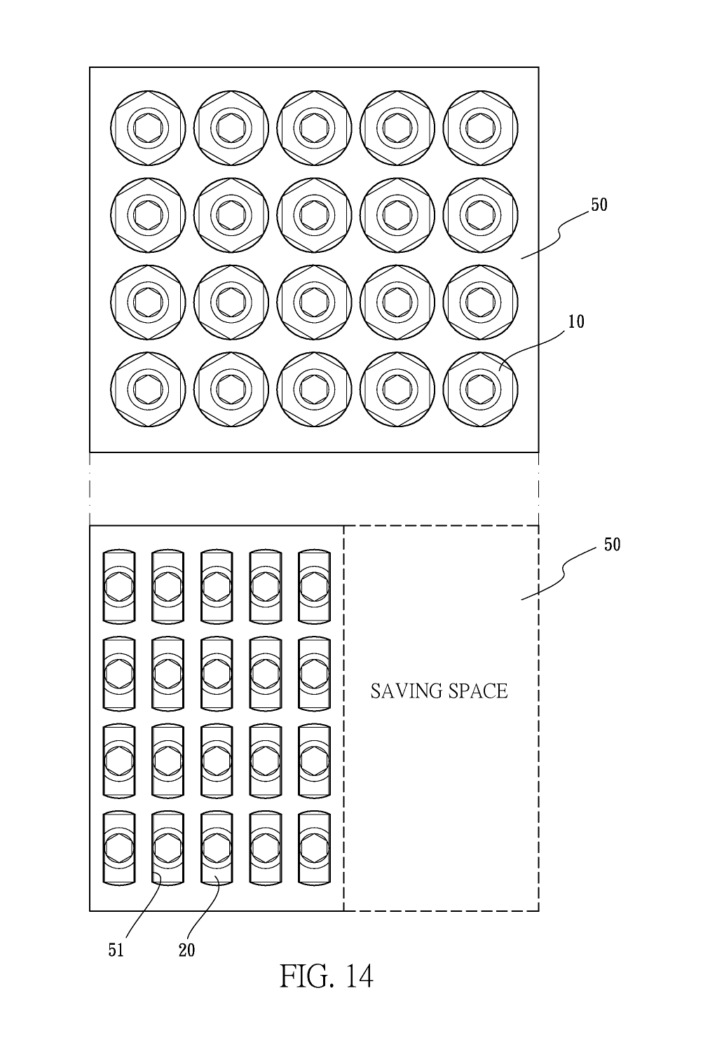

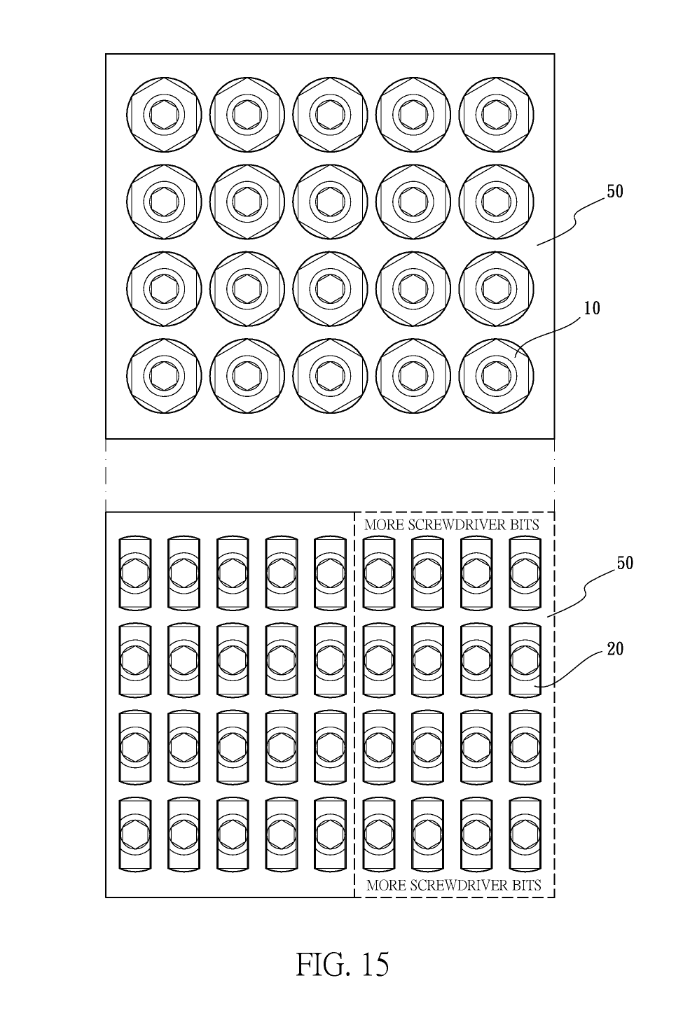

Fifthly, the effect of saving space may be achieved, even the hexagonal hole of a tool box 50 is replaced by another hole with a shape corresponding to the connection end 22 of the screwdriver bit structure 20, shown as FIG. 14.

Sixthly, compared to the conventional screwdriver bit, the number of the screwdriver bit structure 20 of present invention received in the same space is the largest.

Seventhly, the area of the side portions 221 and 222 of the screwdriver bit structure 20 of present invention is the largest and easy to be recognized and manufactured.

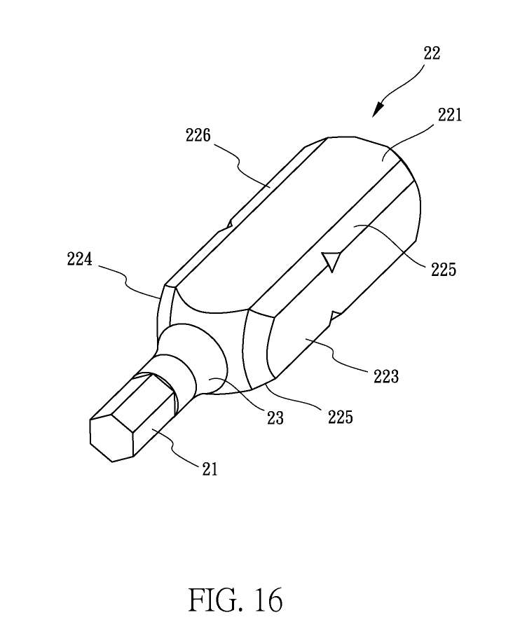

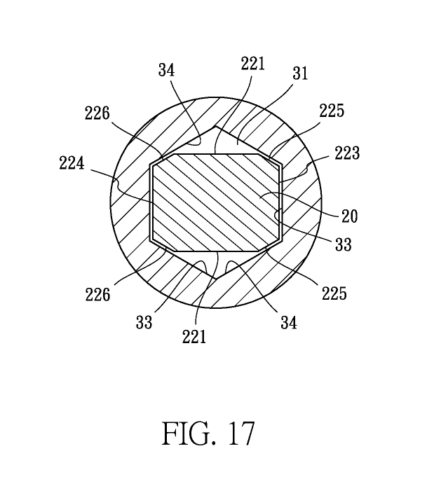

Please refer to FIGS. 16 and 17, two second abutting portions 225 and 226 may be formed from each first abutting portion 225 or 226 toward the side portion 221 or 222 so that the two second abutting portions 225 and 226 are partially engaged at another two opposite surfaces 33 and 34 of the hexagonal hole 31 of the tool 30 which is waited for connection while the larger torque force is needed. Therefore, the second abutting portions 225 and 226 may be further firmly against the hexagonal hole 31. The weight and volume of the screwdriver bit structure may be also reduced and the sleeve of the conventional tool may not be modified.

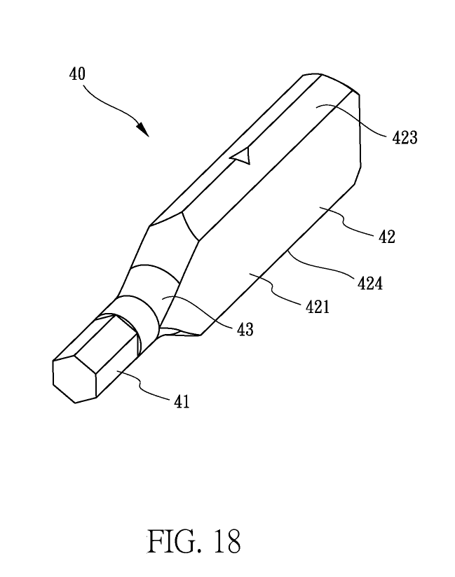

Please refer to FIG. 18, a second embodiment of the screwdriver bit structure 40 of present invention may comprise a driving end 41, a connection end 42, and a neck portion 43. The driving end 41 and the connection end 42 are respectively extended from two ends of the neck portion 43 outwardly. Two side portions 421 and 422 are respectively formed at two sides of the connection end 42 and two third abutting portions 423 and 424 are respectively formed between the two side portions 421 and 422 so that the two third abutting portions 423 and 424 may be respectively partially engaged at two opposite locations of two adjacent surfaces 33 and 34 of the hexagonal hole 31 of the tool 30 which is waited for connection.

Therefore, the weight and volume of the screwdriver bit structure 40 of present invention may be reduced much more. And the sleeve of the conventional tool may not be modified, either.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. A screwdriver bit structure, comprising a driving end, a connection end, and a neck portion, wherein:
the driving end and the connection end are respectively extended from two ends of the neck portion outwardly; and
two side portions are respectively formed at two sides of the connection end and two first abutting portions are respectively formed between the two side portions so that the two first abutting portions are respectively totally engaged at two opposite surfaces of a hexagonal hole of a tool waited for connection.

2. The screwdriver bit structure as claimed in claim 1, wherein two second abutting portions are formed from each first abutting portion toward the side portion so that the two second abutting portion are partially engaged at another two opposite surfaces of the hexagonal hole of the tool waited for connection.

3. A screwdriver bit structure, comprising a driving end, a connection end, and a neck portion, wherein:.
the driving end and the connection end are respectively extended from two ends of the neck portion outwardly; and
two side portions are respectively formed at two sides of the connection end and two third abutting portions are respectively formed between the two side portions so that the two third abutting portions are respectively partially engaged at two opposite locations of two adjacent surfaces of a hexagonal hole of a tool waited for connection.
